(19) United States
(12) Patent Application Publication
(10) Pub. No.: US 2014/0325270 A1
(43) Pub. Date: Oct. 30, 2014

(54) METHOD AND A DEVICE FOR MANAGING AN APPLICATION REFERENCED BY A DEVICE

(71) Applicant: ORANGE, Paris (FR)

(72) Inventors: Sandrine Lacharme, Lannion (FR); Cédric Seureau, Lannion (FR)

(73) Assignee: ORANGE, Paris (FR)

(21) Appl. No.: 14/365,578

(22) PCT Filed: Dec. 7, 2012
(86) PCT No.: PCT/FR2012/052846

§ 371 Date: Jun. 13, 2014

(30) Foreign Application Priority Data
Dec. 16, 2011 (FR) 1161772

(51) Int. Cl. G06F 11/14

(52) U.S. Cl. CPC G06F 11/1458
USPC 714/15

(57) ABSTRACT

This method of managing at least one application referenced by a device (TRM) comprises a step of deleting execution data of said application, said execution data including at least some of the execution context of said application and said execution data that have been stored on remote equipment (SRV), and a step of downloading execution data of said application from said remote equipment.

### BACKGROUND OF THE INVENTION

The present invention lies in the field of electronic devices.

In particular but in non-limiting manner, it applies to electronic devices for home use and having relatively limited storage capacity.

The invention applies in particular to devices constituting a gateway between a home network and an operator network, to set-top boxes forming an interface between a television content distribution network and a television set, and to games consoles.

Numerous terminals nowadays enable users to download or to install new applications. Unfortunately, in the present state of the art, when the resources of the terminal are not sufficient for storing and/or properly executing an application, the user needs to deinstall an application from the terminal or more generally to delete data contained in the terminal in order to release sufficient memory for the new application. This situation is not satisfactory.

One of the objects of the invention is to remedy the shortcomings of the state of the art.

### OBJECT AND SUMMARY OF THE INVENTION

Thus, in a first aspect, the invention provides a method of managing at least one application referenced by a device, the method comprising a step of deleting execution data of the application, the execution data comprising at least part of the execution context of said at least one application and said execution data having been stored on remote equipment, and a step of downloading execution data of said application from said remote equipment by a second device.

Correspondingly, the invention relates to a device including means for deleting execution data of an application referenced on the device, the execution data having been stored in remote equipment.

The device of the invention may be a terminal.

The invention thus makes it possible to release space in the terminal in order to enable another application to be installed or executed but without losing the deleted execution data, which may be recovered from the remote equipment.

In a particular implementation of the invention, the management method of the invention includes a step of backing up execution data of the application in the remote equipment before deleting it.

Backing up in this way is not necessary if the execution data has already been stored in the remote equipment.

In the meaning of this patent application, the remote equipment may be connected to a device of the invention via any type of network, in particular via the network of a telecommunications operator or via a local network, e.g. a home network.

In this sense, the invention lies in the field of “cloud” computing and, in original manner, proposes using the resources of the cloud to back up execution data of applications.

In a preferred implementation, the management method of the invention includes a step of updating a link pointing to the execution data in a memory of the device or in the remote equipment.

This characteristic makes it easy to recover the execution data regardless of whether it is backed up locally in the device or in the remote equipment in order to release space.

In an implementation, the above-mentioned execution data includes at least a portion of the code of the application.

For example, in a particular implementation, the management method of the invention comprises:
a step of receiving a request to install a first application in the device;
a step of deinstalling a second application of the device; and
a step of installing the first application in the device.

In an implementation, the above-mentioned execution data includes at least a portion of the execution context of the application.

The invention thus proposes backing up the execution context of an application that is executable by the device in equipment that is remote, with this context being downloaded by the device only when the application is to be executed.

The invention thus makes it possible to avoid memory being occupied by the execution context of an application that is not being executed.

In this patent application, the notion of an “execution context” specifies the image of an application at a given instant, in other words all of the memory variables and registers known to the application at that given instant.

In accordance with this aspect of the invention, the entire execution context may be backed up in remote equipment, or only a portion thereof, with this second option serving to reduce the time needed for downloading the execution context into the device before executing the application.

For example, the management method of the invention includes a step of executing the application, with the execution context of the application while it is executed being backed up in a memory zone of said device; and
at least one step of sending at least a portion of the memory zone to the remote equipment for storing at least a portion of said execution context on the remote equipment.

In an implementation, the execution method of the invention includes:
a step of downloading an execution context of the application from the remote equipment;
a step of backing up the context in a memory zone of the device; and
a step of executing the application that is performed starting from the context backed up in the memory zone.

In a particular implementation of the invention, the memory zone in which the context of an application is stored is a zone reserved for that application, i.e. it is isolated from the other applications.

By way of example, it is possible for this purpose to make use of a zone that is known to the person skilled in the art as a “sandbox”, where such a zone makes it possible to define an execution environment that is specific to each application and secure, i.e. it is isolated from the other applications.

The characteristics and advantages of the above-mentioned management method may be transposed to the device or the terminal of the invention.

In a particular implementation, the various steps of the execution method and the various steps of the management method are determined by computer program instructions.

Consequently, the invention also provides a computer program on a data medium, the program being suitable for being performed by a computer, the program including instructions adapted to performing steps of the execution method or the steps of the management method as mentioned above.

The invention also provides a computer program on a data medium, the program being suitable for being performed by a computer, the program including instructions adapted to performing steps of the execution method or of the management method as mentioned above.

The program may use any programming language, and it may be in the form of source code, object code, or code intermediate between source code and object code, such as in a partially compiled form, or in any other desireable form.

The invention also provides a computer readable data medium that includes instructions of a computer program as mentioned above.

The data medium may be any entity or device capable of storing the program. For example, the medium may comprise storage means such as a read only memory (ROM), e.g. a compact disk (CD) ROM, or a microelectronic circuit ROM, or indeed magnetic recording means, e.g. a floppy disk or a hard disk.

Furthermore, the data medium may be a transmissible medium such as an electrical or optical signal, suitable for being conveyed via an electrical or optical cable, by radio, or by other means. The program of the invention may in particular be downloaded from an Internet type network.

Alternatively, the data medium may be an integrated circuit in which the program is incorporated, the circuit being adapted to execute or to be used in the execution of the method in question.

### BRIEF DESCRIPTION OF THE DRAWINGS

Other characteristics and advantages of the present invention appear from the following description made with reference to the drawings, which show an implementation having no limiting character.

In the figures:

FIG. 1 is a flow chart showing the main steps of a method of execution and the principles of a management method in accordance with a particular implementation of the invention; and

FIG. 2 is a diagram showing a device in accordance with a particular embodiment of the invention.

### DETAILED DESCRIPTION OF THE INVENTION

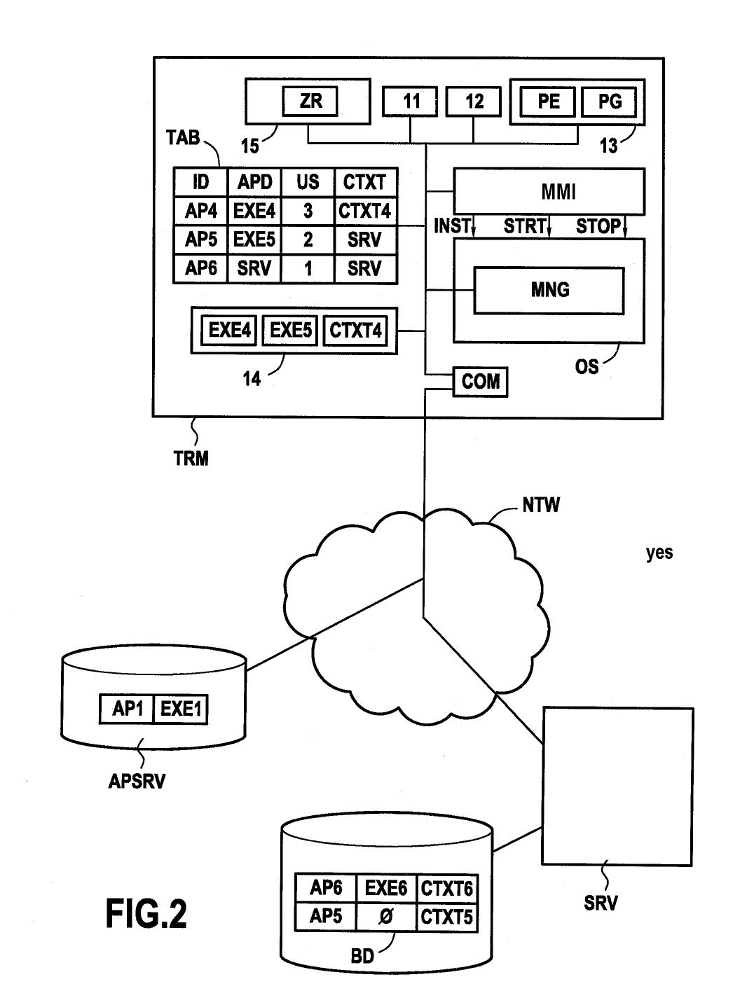

With reference to FIG. 2, there can be seen a device TRM in accordance with the invention.

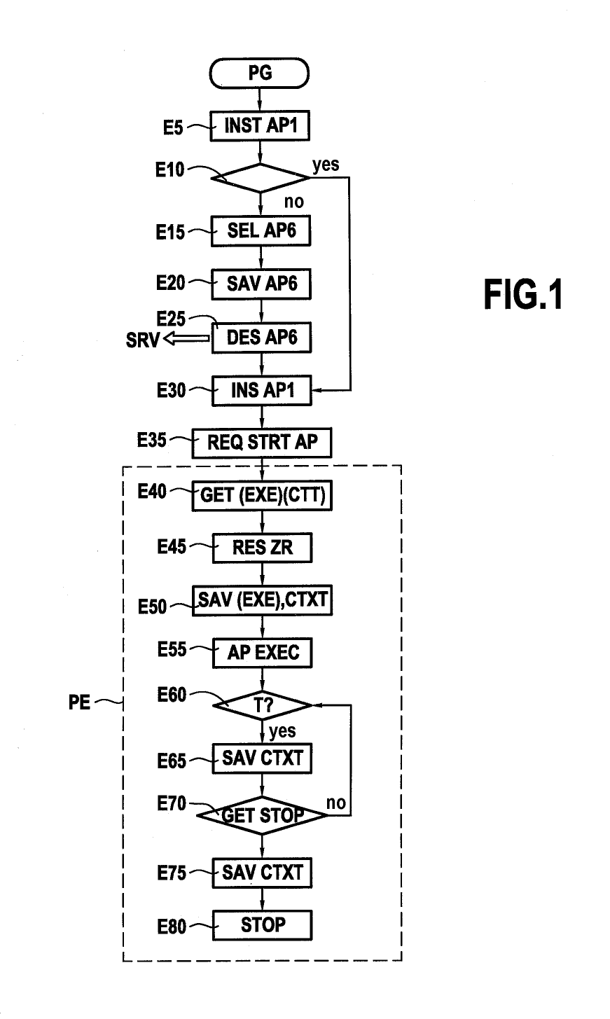

The device has a hardware architecture of a computer. In particular, it comprises a processor 11, a random access memory (RAM) 12, and a ROM 13. The ROM 13 constitutes a data medium in the meaning of the invention; it stores a computer program PG that includes instructions for executing steps of the management method shown in FIG. 1.

The device TRM has an operating system OS and communications means COM enabling the device to communicate via a network NTW with a server SRV and an application server APSRV.

In the presently-described embodiment, the device TRM has a rewritable non-volatile memory 14 storing the executable code EXE4 and EXE5 for two applications AP4 and AP5, and also storing the execution content CTXT4 of the application AP4.

The executable code and the execution context of an application constitute the execution data of the application.

The device TRM has a table TAB storing the states of a plurality of applications, and specifically in this example the states of three applications AP4, AP5, and AP6, and respective links pointing to the execution data of these applications, either in a memory of the device TRM or in a remote server SRV.

In this example, the table TAB shows that:
the code EXE4 and the context CTXT4 of the application AP4 are stored in the memory 14;
the code EXE5 of the application AP5 is stored in the memory 14, while the context CTXT5 of the application is backed up in the remote server SRV; and
the code EXE6 and the context CTXT6 of the application AP6 are backed up in the remote server SRV.

In this example, the device TRM has a module MNG for managing applications that are referenced by the device, and a man-machine interface MMI.

In this example, the remote server SRV stores a database MD including the code EXE6 and the context CTXT6 of the application AP6 and the context CTXT5 of the application AP5.

The application server APSRV is a server from which the device TRM can download a new application AP1 of code EXE1.

The steps E10 to E80 in FIG. 1 show the main steps of a management method in accordance with the invention.

It is assumed that during a step E5 the user of the device TRM seeks to install the application AP1 that is available with the server APSRV.

To this end, the user makes use of the man-machine interface MMI of the device and an installation command INST is issued by the man-machine interface to the management module MNG of the terminal.

During a step E10, the management module MNG verifies whether the memory 14 has sufficient capacity to receive the code EXE1 of the application AP1.

If so, the result of the test E10 is positive and the application is downloaded by the communications means COM and installed in the memory 14.

A new link is created in the table TAB in order to indicate that the executable EXE1 is backed up in the memory 14.

If the flash memory 14 does not enable the code EXE1 of the application AP1 to be installed, the result of the test E10 is negative.

This test is then followed by a step E15 during which the management module MNG selects from the applications that are installed in the device the application that is used the least frequently.

To this end, in the presently-described implementation, the table TAB includes a usage column US including a usage indicator for each of the applications.

In the presently-described implementation, it is assumed that the least used application is the application AP6.

The code EXE6 and the context CXT6 of this application are backed up via the network NTW in the database BD of the server SRV during a step E20.

The application AP6 is deinstalled from the flash memory of the device 14 during a step E25. The links to the execution data of the application AP6 are updated to point to the server SRV.

FIG. 2 shows the state of the table TAB, of the database BD, and of the memory 14 after backing up and deinstalling in this way.

During the step E30, the application AP1 is downloaded by the communications means COM of the device TRM from the application server APSRV and installed in the memory 14.

It is now assumed that the user of the device TRM uses the man-machine interface MMI to launch an application (command STRT).

If the executable EXE and/or the context CTXT of the application are not stored in the memory 14 of the device, the management module MNG acts in a step E40 to follow the application links of this application to download the executable EXT and/or the context CTXT of the application from the server SRV via the network NTW.

During a step E45, the management module MNG reserves a reserve zone ZR in a memory 15 of the device TRM for this application.

It backs up the executable EXE and/or the context CTXT of the application in the reserved zone ZR during a step E50. The links are updated.

Thereafter, during a step E55, the application is executed.

In the presently-described implementation, the management module MNG backs up the execution context CTXT of the application being executed in the remote server SRV on a regular basis, every T seconds.

For this purpose, the execution method of the invention acts during a test E60 to verify whether the duration T has expired.

If it has, the device TRM acts during a step E65 to send all or part of the context CTXT of the application that is currently being executed to the remote server SRV. The links relating to this context are updated.

Thereafter, during a step E70, the terminal verifies whether the user has used the man-machine interface MMI to request that the application be stopped (STOP command).

If so, the terminal TRM backs up the execution context of the application once more in the remote server during a step E75 and stops execution of the application during a step E80.

1. A management method of managing at least one application referenced by a first device, the method comprising:
deleting execution data of said application, said execution data including at least some of the execution context of said application and said execution data that have been stored on remote equipment; and
downloading execution data of said application from said remote equipment.

2. A management method according to claim 1, further including backing up execution data of said application in said remote equipment before said deletion thereof.

3. A management method according to claim 1, further including updating a link pointing to said execution data in a memory of said device or in the remote equipment.

4. An execution method according to claim 1, wherein said execution data includes at least a portion of the code of said application.

5. A management method according to claim 4, further comprising:
receiving a request to install a first application in the device;
deinstalling a second application of the device; and
installing the first application in said device.

6. A management method according to claim 1, further including executing said application, the execution context of said application while it is being executed being backed up in a memory zone of said device; and
at least one process of sending at least a portion of said memory zone to said remote equipment to store at least a portion of said execution context in the remote equipment.

7. An execution method according to claim 1, further comprising:
downloading an execution context of said application from the remote equipment;
backing up said context in a memory zone of said device; and
executing said application that is performed starting from the context backed up in said memory zone.

8. An execution method according to claim 6, wherein said memory zone is a zone reserved for said application, which zone is isolated from the other applications.

9. A device, including:
a component configured to delete execution data of at least one application referenced on the terminal, said execution data including at least part of the execution context of said application and said execution data that have been stored on remote equipment, and a component configured to download execution data of said application from said remote equipment.

10. A management device according to claim 9, comprising a component configured to update a link pointing to said execution data in a memory of said device or in the remote equipment.

11. A computer program including instructions for executing steps of a management method according to claim 1, when said program is executed by a computer.

12. A non-transitory computer readable data medium (13) having stored thereon a computer program including instructions for executing steps of the management method according to claim 1.

13. A management method according to claim 1, wherein the process of downloading execution data of said application from said remote equipment is carried out by a second device.
